(19) United States
(12) Patent Application Publication
(10) Pub. No.: US 2022/0365403 A1
(43) Pub. Date: Nov. 17, 2022

(54) OPTICAL DEVICE, OPTICAL DETECTION SYSTEM, AND OPTICAL FIBER

(71) Applicant: Panasonic Intellectual Property Management Co., Ltd., Osaka (JP)

(72) Inventors: TAKAIKI NOMURA, Osaka (JP); KAZUKI NAKAMURA, Osaka (JP); AKIRA HASHIYA, Osaka (JP); YASUHISA INADA, Osaka (JP)

(21) Appl. No.: 17/810,835

(22) Filed: Jul. 6, 2022

Related U.S. Application Data
(63) Continuation of application No. PCT/JP2020/047882, filed on Dec. 22, 2020.

(30) Foreign Application Priority Data
Jan. 31, 2020 (JP) 2020-014469

(51) Int. Cl. G02F 1/295; G01S 17/08; G01S 7/481

(52) U.S. Cl. CPC G02F 1/2955; G01S 17/08; G01S 7/4817; G01S 7/4818

(57) ABSTRACT

An optical device includes a first substrate with a first surface spreading in a first direction and a second direction intersecting the first direction, a second substrate with a second surface facing the first surface, a film bonded to the first surface and/or the second surface through a siloxane bond, and at least one optical guide layer positioned between the first substrate and the second substrate, the optical guide layer including a dielectric member in contact with the film and guiding light in the first direction and/or the second direction.

### BACKGROUND

### 1. Technical Field

The present disclosure relates to an optical device, an optical detection system, and an optical fiber.

### 2. Description of the Related Art

Various devices capable of scanning a space with light have been proposed so far.

International Publication No. 2013/168266 discloses a configuration that can perform a light scan by using a drive device rotating a mirror.

Japanese Unexamined Patent Application Publication (Translation of PCT Application) No. 2016-508235 discloses an optical phased array including nano-photonic antenna elements that are two-dimensionally arrayed. The antenna elements are each optically coupled to a variable optical delay line (namely, a phase shifter). In the disclosed optical phased array, a coherent light beam is guided to each antenna element through a waveguide, and a phase of the light beam is shifted by the phase shifter. With such a configuration, an amplitude distribution of a far field radiation pattern can be changed.

Japanese Unexamined Patent Application Publication No. 2013-16591 discloses a light deflection element including a waveguide that includes an optical guide layer through which light is guided and a first distribution Bragg reflecting mirror formed on each of an upper surface and a lower surface of the optical guide layer, a light inlet through which the light is introduced into the waveguide, and a light outlet formed in a surface of the waveguide to emit the light having been introduced from the light inlet and guided through the waveguide.

### SUMMARY

One non-limiting and exemplary embodiment provides a novel optical device capable of realizing a light scan with a relatively simple configuration and less light loss.

In one general aspect, the techniques disclosed here feature an optical device including a first substrate with a first surface spreading in a first direction and a second direction intersecting the first direction, a second substrate with a second surface facing the first surface, a film bonded to the first surface and/or the second surface through a siloxane bond, and at least one optical guide layer positioned between the first substrate and the second substrate, the optical guide layer including a dielectric member in contact with the film and guiding light in the first direction and/or the second direction. A generic or specific embodiment of the present disclosure may be realized as a device, a system, a method, or an optional combination of the formers.

According to an embodiment of the present disclosure, a one-dimensional scan or a two-dimensional scan with light can be realized with relatively simple configuration and less light loss.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic perspective view of a configuration of an optical scanning device;

FIG. 2 is a schematic view illustrating an example of a sectional structure of one waveguide element and an example of propagating light;

FIG. 3A illustrates a cross-section of a waveguide array that emits light in a direction perpendicular to an exit surface of the waveguide array;

FIG. 3B illustrates a cross-section of a waveguide array that emits light in a direction different from the direction perpendicular to an exit surface of the waveguide array;

FIG. 4 is a schematic perspective view illustrating a waveguide array in a three-dimensional space;

FIG. 5 is a schematic view when a waveguide array 10A and a phase shifter array 80A are viewed from a direction normal to a light exit surface (namely, from a Z-direction);

FIG. 6A is a schematic view illustrating an example of an optical device according to a first embodiment of the present disclosure when viewed from the Z-direction;

FIG. 6B illustrates the optical device of FIG. 6A from which an upper structure body is omitted;

FIG. 7A is a schematic view taken along line VIIA-VIIA in FIG. 6A;

FIG. 7B is a schematic view taken along line VIIB-VIIB in FIG. 6A;

FIG. 7C is a schematic view taken along line VIIC-VIIC in FIG. 6A;

FIG. 8A is an explanatory view illustrating a film in the first embodiment;

FIG. 8B is an explanatory view illustrating the film in the first embodiment;

FIG. 8C is an explanatory view illustrating the film in the first embodiment;

FIG. 8D is an explanatory view illustrating the film in the first embodiment;

FIG. 8E is an explanatory view illustrating the film in the first embodiment;

FIG. 9 is a schematic view illustrating exiting of light from the optical device;

FIG. 10 illustrates an example of configuration of the optical scanning device in which individual elements, such as an optical demultiplexer, the waveguide array, the phase shifter array, and a light source, are integrated on a circuit board;

FIG. 11 is a schematic view illustrating a situation in which a two-dimensional scan is performed by emitting a light beam, such as a laser beam, to a far field from the optical scanning device;

FIG. 12 is a block diagram illustrating an example of configuration of a LiDAR system capable of creating a distance measurement image; and

FIG. 13 is a schematic view illustrating an example of an optical fiber according to a second embodiment of the present disclosure.

### DETAILED DESCRIPTIONS

The underlying knowledge forming the basis of the present disclosure is described prior to explaining embodiments of the present disclosure

The inventors have found that an optical scanning device of related art has a difficulty in scanning a space with light without making a device configuration complicated.

For example, the technique disclosed in International Publication No. 2013/168266 needs the drive device rotating the mirror. Therefore, the device configuration is complicated, and the device is not robust against vibrations.

In the optical phased array disclosed in Japanese Unexamined Patent Application Publication (Translation of PCT Application) No. 2016-508235, it is needed to demultiplex light, to introduce the demultiplexed lights to column waveguides and row waveguides, and to guide those lights to the antenna elements that are two-dimensionally arrayed. Therefore, routing of the waveguides for guiding the lights becomes very complicated. Moreover, a two-dimensional scan cannot be realized in a large range. In addition, to two-dimensionally change the amplitude distribution of emitted light in the far field, a phase shifter has to be connected to each of the two-dimensionally arrayed antenna elements, and a wiring line for phase control has to be attached to the phase shifter. With such a configuration, phases of lights incident on the two-dimensionally arrayed antenna elements are changed in different amounts. Hence a device configuration is very complicated.

The inventors have focused on the above-described problems in the related art and has studied techniques to solve the problems. The inventors have found that the above-described problems can be solved by using a waveguide element including a pair of mirrors facing each other and an optical guide layer sandwiched between the mirrors. One of the pair of mirrors in the waveguide element has a higher light transmittance than the other mirror and causes part of light propagating in the optical guide layer to be emitted to the outside. As described later, a direction (or an exit angle) of the emitted light can be changed by adjusting a refractive index or a thickness of the optical guide layer or a wavelength of light input to the optical guide layer. More specifically, a component of a wave vector of the emitted light along a lengthwise direction of the optical guide layer can be changed by changing the refractive index, the thickness, or the wavelength. As a result, a one-dimensional scan can be realized.

Furthermore, a two-dimensional scan can also be realized in the case of using an array of waveguide elements. In more detail, a direction in which lights emitted from the waveguide elements strengthen each other can be changed by giving an appropriate phase difference between lights supplied to the waveguide elements and by adjusting the phase difference. With the change of the phase difference, components of wave vectors of the emitted lights in a direction intersecting the lengthwise direction of the optical guide layers are changed. This enables the two-dimensional scan to be realized. Even when the two-dimensional scan is performed, it is not required to change the refractive indexes or the thicknesses of the optical guide layers or the light wavelengths in different amounts. In other words, the two-dimensional scan can be performed by giving the appropriate phase difference between the lights supplied to the optical guide layers and by synchronously changing at least ones of the refractive indexes or the thicknesses of the optical guide layers or the wavelengths in the same amount. Thus, according to an embodiment of the present disclosure, the two-dimensional scan with light can also be realized with a relatively simple configuration.

In this Specification, the wording “at least one of the refractive index, the thickness, or the wavelength” indicates at least one selected from the group consisting of the refractive index of the optical guide layer, the thickness of the optical guide layer, or the wavelength of the light input to the optical guide layer. To change a light exit direction, any one of the refractive index, the thickness, or the wavelength may be controlled alone. Alternatively, arbitrary two or all of those three parameters may be controlled to change the light exit direction. In each of embodiments described below, the wavelength of the light input to the optical guide layer may be controlled instead of or in addition to control of the refractive index or the thickness.

The above-described basic principle can be applied in a similar manner to not only the case of emitting light, but also the case of receiving an optical signal. A direction in which light is receivable can be one-dimensionally changed by changing at least one of the refractive index, the thickness, or the wavelength. Furthermore, the direction in which light is receivable can be two-dimensionally changed by changing a phase difference between lights with phase shifters connected to the waveguide elements in a one-to-one relation, those waveguide elements being arrayed in one direction.

An optical scanning device and a light receiving device according to the embodiment of the present disclosure are each used as an antenna in an optical detection system such as LiDAR (Light Detection and Ranging) system, for example. An LiDAR system can detect a distance distribution of objects with higher resolution in comparison with a radar system using a millimeter wave because of using an electrical wave (visible light, an infrared ray, or an ultraviolet ray) of a shorter wavelength. Such an LiDAR system may be mounted on a mobile unit such as a car, a UAV (Unmanned Aerial Vehicle, so-called drone), or an AGV (Automated Guided Vehicle), for example, and may be used as one of collision avoidance techniques. In this Specification, the optical scanning device and the light receiving device are collectively referred to as an “optical device” in some cases. In addition, a device used in the optical scanning device or the light receiving device is also referred to as an “optical device” in some cases.

### Example of Configuration of Optical Scanning Device

A configuration of the optical scanning device performing a two-dimensional scan will be described below as an example. However, more detailed description than necessary is omitted in some cases. For example, detailed description of the well-known matters and duplicate description of substantially the same configuration are omitted in some cases. This is to avoid the following description from becoming too redundant and to promote easier understanding of those skilled in the art. Furthermore, the inventors present the accompanying drawing and the following description for enabling those skilled in the art to sufficiently understand the present disclosure, and the accompanying drawing and the following description are not intended to restrict the subject matter stated in Claims. In the following description, the same or similar components are denoted by the same reference signs.

In the present disclosure, the word “light” indicates not only visible light (of wavelength longer than or equal to about 400 nm and shorter than or equal to about 700 nm), but also electromagnetic waves including an ultraviolet ray (of wavelength longer than or equal to about 10 nm and shorter than or equal to about 400 nm) and an infrared ray (of wavelength longer than or equal to about 700 nm and shorter than or equal to about 1 mm). In this Specification, the ultraviolet ray is referred to as “ultraviolet light”, and the infrared ray is referred to as “infrared light” in some cases.

In the present disclosure, the word “scan” with light indicates that a direction of the light is changed. The wording “one-dimensional scan” indicates that the direction of the light is linearly changed along a direction intersecting the direction of the light. The wording “two-dimensional scan” indicates that the direction of the light is two-dimensionally changed along a plane intersecting the direction of the light.

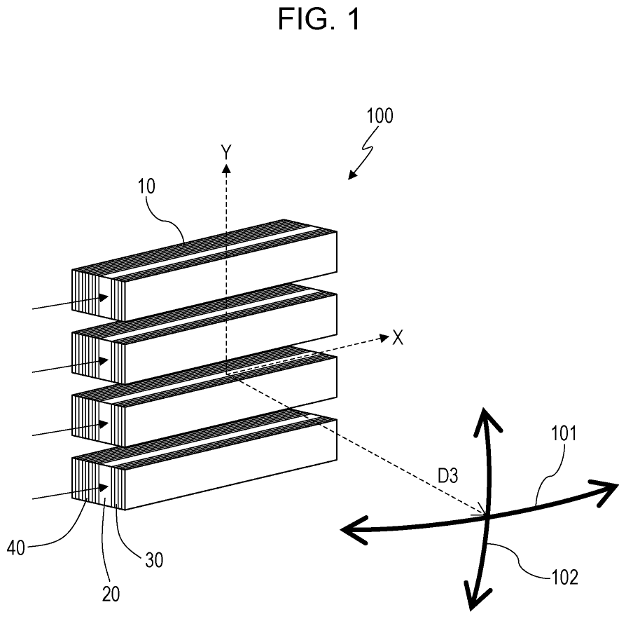

FIG. 1 is a schematic perspective view of a configuration of an optical scanning device 100. The optical scanning device 100 includes a waveguide array including waveguide elements 10. Each of the waveguide elements 10 has a shape extending in a first direction (X-direction in FIG. 1). The waveguide elements 10 are regularly arrayed in a second direction (Y-direction in FIG. 1) intersecting the first direction. The waveguide elements 10 emit lights in a third direction D3 intersecting an imaginary plane parallel to the first and second directions while allowing the lights to propagate in the first direction. Although the first direction (X-direction) and the second direction (Y-direction) are orthogonal to each other in this embodiment, those directions are not always required to be orthogonal to each other. Although the waveguide elements 10 are arrayed at equal intervals in the Y-direction in this embodiment, they are not always required to be arrayed at equal intervals.

An orientation of a structure body illustrated in the drawings attached to this application is set in consideration of easy understanding of the description and is not intended to restrict the orientation when the embodiment of the present disclosure is actually put into practice. A shape and a size of the whole or part of the structure body, illustrated in the drawings, are also not intended to restrict an actual shape and size in practical use.

Each of the waveguide elements 10 includes a pair of a first mirror 30 and a second mirror 40 facing each other (which are each simply referred to as a “mirror” in some cases hereinafter), and an optical guide layer 20 sandwiched between the mirror 30 and the mirror 40. Each of the mirror 30 and the mirror 40 has, at an interface with the optical guide layer 20, a reflecting surface intersecting the third direction D3. The mirror 30, the mirror 40, and the optical guide layer 20 have shapes extending in the first direction (X-direction).

As described later, the first mirrors 30 of the waveguide elements 10 may be portions of an integrally formed mirror. The second mirrors 40 of the waveguide elements 10 may be portions of an integrally formed mirror. Furthermore, the optical guide layers 20 of the waveguide elements 10 may be portions of an integrally formed optical guide layer. Waveguides can be formed on condition of satisfying at least one of (1) each first mirror 30 is constituted separately from another first mirror 30, (2) each second mirror 40 is constituted separately from another second mirror 40, or (3) each optical guide layer 20 is constituted separately from another optical guide layer 20. The wording “constituted separately” indicates not only the case of physically forming a space between two members, but also the case of separating two members by sandwiching a material with a different refractive index between the two members.

The reflecting surface of the first mirror 30 and the reflecting surface of the second mirror 40 face each other substantially parallel. Of the two mirrors 30 and 40, at least the first mirror 30 has a characteristic of allowing part of light propagating in the optical guide layer 20 to pass through the first mirror 30. In other words, the first mirror 30 has a higher light transmittance for the propagating light than the second mirror 40. Therefore, part of the light propagating in the optical guide layer 20 is emitted to the outside from the first mirror 30. The above-described mirrors 30 and 40 may be each, for example, a multilayer film mirror that is formed of a multilayer film (also referred to as a “multilayer reflecting film” in some cases) made of a dielectric.

The two-dimensional scan with light can be realized by controlling a phase of the light input to each of the waveguide element 10, and by synchronously changing refractive indexes or thicknesses of the optical guide layers 20 in the waveguide elements 10 or wavelengths of lights input to the optical guide layers 20 at the same time.

To realize the above-described two-dimensional scan, the inventors have analyzed the operating principle of the waveguide element 10. On the basis of the analysis result, the inventors have succeeded in realizing the two-dimensional scan with light by synchronously driving the waveguide elements 10.

As illustrated in FIG. 1, when lights are input to the waveguide elements 10, the lights are emitted from exit surfaces of the waveguide elements 10. The exit surfaces are positioned on an opposite side to the reflecting surface of the first mirror 30. The direction D3 of each emitted light depends on the refractive index and the thickness of the optical guide layer and the light wavelength. In this embodiment, at least ones of the refractive indexes or the thicknesses of the individual optical guide layers or the wavelengths are controlled synchronously such that the lights are emitted from the individual waveguide elements 10 substantially in the same direction. As a result, X-directional components of the wave vectors of the lights emitted from the waveguide elements 10 can be changed. In other words, the direction D3 of the emitted light can be changed along a direction 101 illustrated in FIG. 1.

Furthermore, since the lights emitted from the waveguide elements 10 are oriented in the same direction, the emitted lights interfere with each other. Therefore, a direction in which the lights strengthen each other with interference can be changed by controlling phases of the lights emitted from the waveguide elements 10. For example, when the waveguide elements 10 of the same size are arrayed at equal intervals in the Y-direction, lights with phases different in units of a certain amount are input to the waveguide elements 10. By changing a difference between the phases, Y-directional components of the wave vectors of the emitted lights can be changed. In other words, by changing the phase difference between the lights introduced to the waveguide elements 10, the direction D3 in which the emitted lights strengthen each other with interference can be changed along a direction 102 illustrated in FIG. 1. As a result, the two-dimensional scan with light can be realized.

The operating principle of the optical scanning device 100 will be described below.

### Operating Principle of Waveguide Element

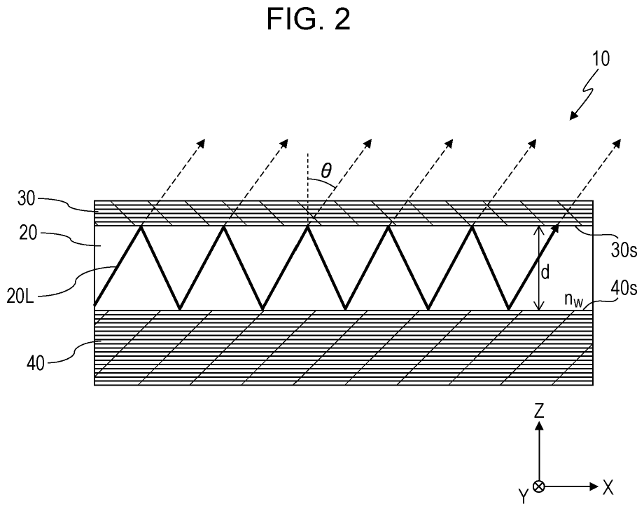

FIG. 2 is a schematic view illustrating an example of a sectional structure of one waveguide element 10 and an example of propagating light. In FIG. 2, a direction perpendicular to the X-direction and the Y-direction illustrated in FIG. 1 is assumed to be a Z-direction, and a cross-section of the waveguide element 10 parallel to an XZ plane is schematically illustrated. In the waveguide element 10, the first mirror 30 and the second mirror 40 are disposed with the optical guide layer 20 sandwiched therebetween. A first reflecting surface 30s of the first mirror 30 and a second reflecting surface 40s of the second mirror 40 face each other. In this Specification, the “first reflecting surface 30s” is simply referred to as a “reflecting surface 30s”, and the “second reflecting surface 40s” is simply referred to as a “reflecting surface 40s” in some cases. Light 20L introduced from one end of the optical guide layer 20 in the X-direction propagates in the optical guide layer 20 while repeatedly reflecting at the first reflecting surface 30s of the first mirror 30 disposed on an upper surface (surface on an upper side in FIG. 2) of the optical guide layer 20 and at the second reflecting surface 40s of the second mirror 40 disposed on a lower surface (surface on a lower side in FIG. 2) of the optical guide layer 20. The light transmittance of the first mirror 30 is higher than that of the second mirror 40. Accordingly, part of the light can be output mainly from the first mirror 30.

In a waveguide such as a usual optical fiber, light propagates along the waveguide while repeating total reflection. By contrast, in the waveguide element 10 according to this embodiment, the light propagates while repeatedly reflecting at the mirrors 30 and 40 disposed respectively on upper and lower sides of the optical guide layer 20. Accordingly, there are no restrictions on a light propagation angle. Here, the term “light propagation angle” indicates an angle incident on an interface between the mirror 30 or the mirror 40 and the optical guide layer 20. Even light incident on the mirror 30 or the mirror 40 at an angle closer to a right angle can propagate in the optical guide layer 20. In other words, light incident on the interface at a smaller angle than a critical angle for total reflection can also propagate. Therefore, the group velocity of the light in the light propagation direction is greatly reduced in comparison with the light velocity in a free space. As a result, the waveguide element 10 has such a property that light propagation conditions are greatly changed with respect to change in light wavelength, thickness of the optical guide layer 20, and refractive index of the optical guide layer 20. The waveguide with such a property is referred to as a “reflection waveguide” or a “slow light waveguide”.

An exit angle θ of light emitted from the waveguide element 10 into air is expressed by the following formula (1).

$$sin θ \sqrt{{n}_{w}^{2} - {( \frac{m λ}{2 d} )}^{2}} \qquad ( 1 )$$

As seen from the formula (1), the light exit direction can be changed by changing any of a light wavelength λ in air, a refractive index n_{w} of the optical guide layer 20, and a thickness d of the optical guide layer 20.

In the case of n_{w}=2, d=387 nm, λ=1550 nm, and m=1, for example, the exit angle is 0°. When the refractive index is changed to n_{w}=2.2 from the above condition, the exit angle is changed to about 66°. On the other hand, when the thickness is changed to d=420 nm without changing the refractive index, the exit angle is changed to about 51°. When the wavelength is changed to λ=1500 nm without changing the refractive index and the thickness, the exit angle is changed to about 30°. Thus, the light exit direction can be greatly changed by changing any of the light wavelength λ, the refractive index n_{w} of the optical guide layer 20, and the thickness d of the optical guide layer 20.

From the above point of view, in the optical scanning device 100 according to the embodiment of the present disclosure, the light exit direction is controlled by controlling at least one of the wavelength λ of the light input to the optical guide layer 20, the refractive index n_{w} of the optical guide layer 20, or the thickness d of the optical guide layer 20. The wavelength λ of the input light may be kept constant without changing it during the operation. In that case, the light scan can be realized with a simpler configuration. The wavelength λ is not limited to a particular value. For example, the wavelength λ may be within a wavelength range from 400 nm to 1100 nm (from visible light to near infrared light) where high detection sensitivity is obtained with a general photodetector or image sensor that detects light by absorbing the light with silicon (Si). In another example, the wavelength λ may be within a near-infrared wavelength range from 1260 nm to 1625 nm where transmission loss in an optical fiber or a Si waveguide is relatively small. The above-mentioned wavelength ranges are merely examples. The wavelength range of the light used is not limited to the wavelength range of visible light or infrared light and may be a wavelength range of ultraviolet light.

To change the direction of the emitted light, the optical scanning device 100 may include a first adjuster that changes at least one of the refractive index or the thickness of the optical guide layer 20 or the wavelength in each waveguide element 10.

As described above, the light exit direction can be greatly changed with the waveguide element 10 by changing at least one of the refractive index n_{w} or the thickness d of the optical guide layer 20 or the wavelength λ. Accordingly, the exit angle of the light emitted from the mirror 30 can be changed in the direction along the waveguide element 10. Hence the one-dimensional scan can be realized by using at least one waveguide element 10.

To adjust the refractive index of at least part of the optical guide layer 20, the optical guide layer 20 may contain a liquid crystal material or an electro-optic material.

The optical guide layer 20 may be sandwiched between a pair of electrodes. The refractive index of the optical guide layer 20 can be changed by applying a voltage between the pair of electrodes.

To adjust the thickness of the optical guide layer 20, for example, at least one actuator may be connected to at least one of the first mirror 30 or the second mirror 40. The thickness of the optical guide layer 20 can be changed by changing a distance between the first mirror 30 and the second mirror 40 with the at least one actuator. The thickness of the optical guide layer 20 can be easily changed when the optical guide layer 20 is made of a liquid.

### Operating Principle for Two-Dimensional Scan

In the waveguide array in which the waveguide elements 10 are arrayed in one direction, the light exit direction is changed with interference of the lights emitted from the waveguide elements 10. The light exit direction can be changed by adjusting phases of lights supplied to the waveguide elements 10. The principle of such operation will be described below.

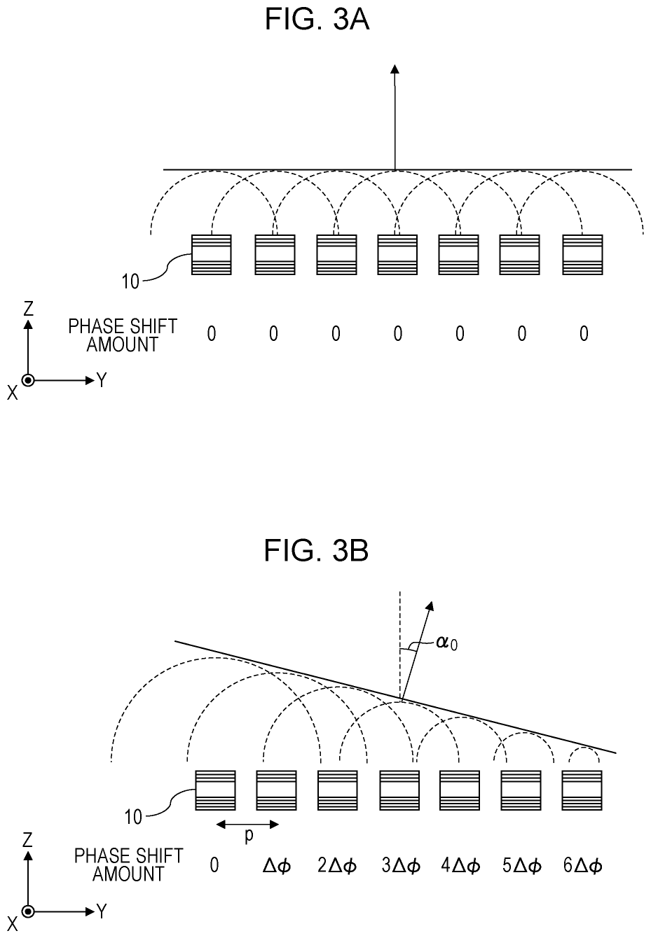

FIG. 3A illustrates a cross-section of a waveguide array that emits light in a direction perpendicular to an exit surface of the waveguide array. FIG. 3A further illustrates a phase shift amount of the light propagating in each waveguide element 10. Here, the phase shift amount is a value on the basis of a phase of the light propagating in the waveguide element 10 at a left end. The waveguide array in this embodiment includes the waveguide elements 10 arrayed at equal intervals. In FIG. 3A, a circular arc denoted by a dashed line represents a wave front of the light emitted from each the waveguide element 10. A linear line represents a wave front formed by the light interference. An arrow represents a direction of light emitted from the waveguide array (namely, a direction of a wave vector). In the example of FIG. 3A, the phases of the lights propagating in the optical guide layers 20 in the individual waveguide elements 10 are the same. In this case, the light is emitted in a direction (Z-direction) perpendicular to both the direction (Y-direction) in which the waveguide elements 10 are arrayed and the direction (X-direction) in which the optical guide layers 20 extend.

FIG. 3B illustrates a cross-section of a waveguide array that emits light in a direction different from the direction perpendicular to an exit surface of the waveguide array. In the example of FIG. 3B, the phases of the lights propagating in the optical guide layers 20 in the individual waveguide elements 10 are different in units of a certain amount (Δϕ) in the array direction. In this case, the light is emitted in a direction different from the Z-direction. A component of a wave vector of each light in the Y-direction can be changed by changing Δϕ. Assuming that a center-to-center distance between two adjacent waveguide elements 10 is denoted by p, a light exit angle α₀ is expressed by the following formula (2).

$$sin {α}_{0} = \frac{Δϕλ}{2 π p} \qquad ( 2 )$$

In the example illustrated in FIG. 2, the light exit direction is parallel to the XZ plane. Thus, α₀=0°. In the example illustrated in FIGS. 3A and 3B, the direction of the light emitted from the optical scanning device 100 is parallel to a YZ plane. Thus, θ=0°. In general, however, the direction of the light emitted from the optical scanning device 100 is not parallel to the ZX plane and YZ plane. Thus, θ≠0° and α₀≠0°.

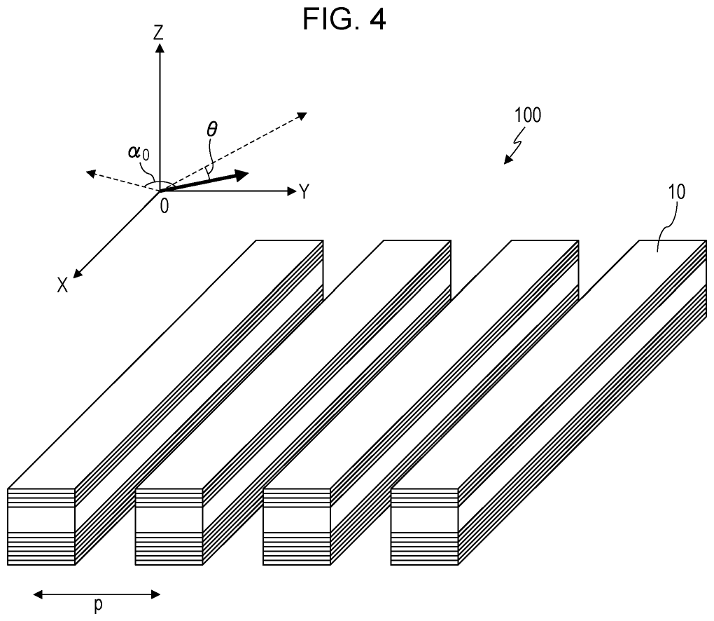

FIG. 4 is a schematic perspective view illustrating a waveguide array in a three-dimensional space. A thick arrow illustrated in FIG. 4 represents a direction of the light emitted from the optical scanning device 100. θ represents an angle formed between the light exit direction and the YZ plane. θ satisfies the formula (1). α₀ represents an angle formed between the light exit direction and the XZ plane. α₀ satisfies the formula (2). Phase Control of Lights Introduced to Waveguide Array

To control the phase of the light emitted from each waveguide element 10, a phase shifter for changing the light phase may be disposed, for example, in a stage prior to introducing the light to the waveguide element 10. The optical scanning device 100 in this embodiment includes phase shifters connected to the waveguide elements 10 in a one-to-one relation, and second adjusters adjusting phases of lights propagating through the phase shifters. Each of the phase shifters includes a waveguide connected directly or via another waveguide to the optical guide layer 20 in corresponding one of the waveguide elements 10. The second adjusters change a phase difference between the lights propagating from the phase shifters to the waveguide elements 10, thereby changing the direction in which the light is emitted from each waveguide element 10 (namely, the third direction D3). In the following description, like the waveguide array, the arrayed phase shifters are also referred to as a “phase shifter array” in some cases.

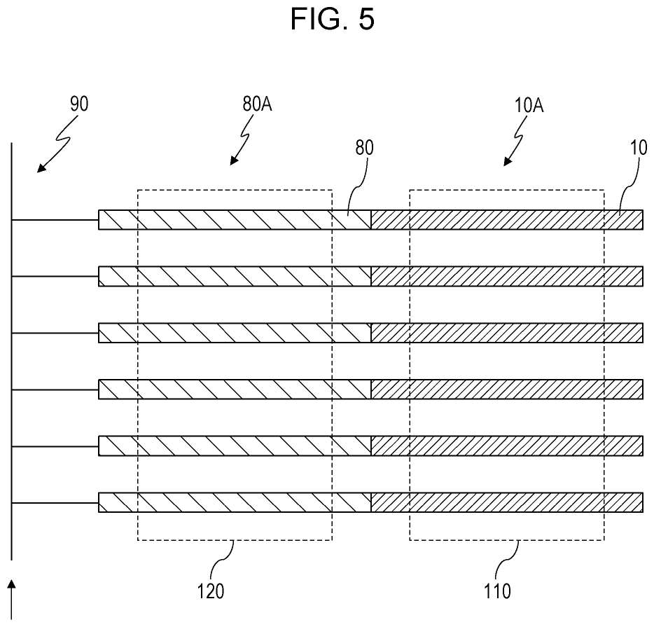

FIG. 5 is a schematic view when the waveguide array 10A and a phase shifter array 80A are viewed from a direction normal to the light exit surface (namely, from the Z-direction). In the example illustrated in FIG. 5, all phase shifters 80 have the same propagation characteristic, and all the waveguide elements 10 have the same propagation characteristic. The lengths of the phase shifters 80 may be the same or different, and the lengths of the waveguide elements 10 may be the same or different. When the lengths of the phase shifters 80 are the same, phase shift amounts given by the phase shifters 80 can be adjusted with drive voltages, for example. Alternatively, with a structure in which the lengths of the phase shifters 80 are changed in equal steps, phase shifts changing in equal steps can be given by applying the same drive voltage. The optical scanning device 100 in this embodiment further includes an optical demultiplexer 90 that demultiplexes light and supplies demultiplexed lights to the phase shifters 80, a first drive circuit 110 that drives the waveguide elements 10, and a second drive circuit 120 that drives the phase shifters 80. A linear arrow in FIG. 5 represents an input of the light. The two-dimensional scan can be realized by controlling the first drive circuit 110 and the second drive circuit 120 independently. In the illustrated example, the first drive circuit 110 functions as one element of the first adjuster, and the second drive circuit 120 functions as one element of the second adjuster.

The first drive circuit 110 changes an angle of the light emitted from the optical guide layer 20 by changing at least one of the refractive index or the thickness of the optical guide layer 20 in each waveguide element 10. The second drive circuit 120 changes a phase of the light propagating through a waveguide in each phase shifter 80 by changing a refractive index of the waveguide. The optical demultiplexer 90 may be constituted by a waveguide through which light propagates with total reflection, or by a reflection waveguide like the waveguide element 10.

In another example, after controlling the phases of the lights demultiplexed by the optical demultiplexer 90, the lights may be introduced to the phase shifters 80. For such phase control, for example, a passive phase control structure adjusting the lengths of waveguides up to the phase shifters 80 can be used. Alternatively, other phase shifters may be used which have similar functions to those of the phase shifters 80 and which are able to perform control with electric signals. The above-mentioned methods may be optionally used to adjust the phases of the lights before being introduced to the phase shifters 80 such that the lights in the same phase are supplied to all the phase shifters 80. With that adjustment, control of the phase shifters 80 by the second drive circuit 120 can be simplified.

An optical device with a similar configuration to that of the above-described optical scanning device 100 can also utilized as a light receiving device. Details of the operating principle and method for such an optical device are disclosed in U.S. Unexamined Patent Application Publication No. 2018/0224709. The entire contents disclosed in the above-mentioned document are incorporated in this Specification by reference.

### Liquid Crystal Alignment Film

When the optical guide layer 20 contains a liquid crystal material, an alignment film made of polyimide, for example, may be disposed on the reflecting surface 30s of the mirror 30 and/or the reflecting surface 40s of the mirror 40 for alignment of the liquid crystal material. The polyimide alignment film is thick and nonuniform. The polyimide alignment film has a thickness of about 80 nm, and a variation of the thickness is more than or equal to 0 nm and less than or equal to 150 nm. When light enters the thick and nonuniform polyimide alignment film, absorption and scattering of the light occur. Accordingly, when the light propagates in the optical guide layer 20 along the X-direction with multiple reflections as illustrated in FIG. 2, the light is absorbed and scattered many times by the polyimide alignment film. Hence non-negligible light loss may be caused in the optical guide layer 20. According to the study made by the inventors, the light loss is about 50%.

When, in a process of fabricating the optical scanning device 100, the polyimide alignment film is disposed on the reflecting surface 30s of the mirror 30 and/or the reflecting surface 40s of the mirror 40, the polyimide alignment film may be disposed additionally on the electrodes for applying the voltage to the optical guide layer 20. The polyimide alignment film may function as an insulating film. For that reason, the polyimide alignment film disposed on the electrodes are removed. Alternatively, the polyimide alignment film is formed only on the reflecting surface 30s of the mirror 30 and/or the reflecting surface 40s of the mirror 40 with masking. This may increase the number of steps in fabricating the optical device.

With the above-described study, the inventors have conceived an optical device according to each aspect mentioned below. In the optical device according to the present disclosure, instead of the polyimide alignment film, a film bonded through a siloxane bond between Si and O (see, for example, Japanese Unexamined Patent Application Publication No. 2001-100214) is disposed on at least one of a first surface of a first substrate or a second surface of a second substrate with an optical guide layer positioned between the first and second surfaces. The film can suppress light loss caused in the optical guide layer. Furthermore, the film disposed on an electrode does not function as an insulating film. Accordingly, there is no necessity of removing the film disposed on portions other than the first surface and/or the second surface, and of forming the film only on the first surface and/or the second surface with masking. As a result, fabrication of the optical device is facilitated.

An optical device according to a first aspect includes a first substrate with a first surface spreading in a first direction and a second direction intersecting the first direction, a second substrate with a second surface facing the first surface, a film bonded to the first surface and/or the second surface through a siloxane bond, and at least one optical guide layer positioned between the first substrate and the second substrate, the optical guide layer including a dielectric member in contact with the film and guiding light in the first direction and/or the second direction.

With the above optical device, a light scan can be realized with a relatively simple configuration and less light loss.

An optical device according to a second aspect is featured in further including, in the optical device according to the first aspect, at least one optical waveguide connected to the optical guide layer.

With the above optical device, light can be supplied to the optical guide layer from the at least one optical waveguide.

An optical device according to a third aspect is featured in that, in the optical device according to the second aspect, a fore end portion of the optical waveguide is positioned between the first substrate and the second substrate. The optical waveguide includes a first grating in the fore end portion.

With the above optical device, light propagating in the optical waveguide can be efficiently coupled to the optical guide layer through the first grating.

An optical device according to a fourth aspect is featured in that, in the optical device according to the second or third aspect, the optical waveguide includes a portion not overlapping one of the first substrate and the second substrate when viewed from a direction perpendicular to the first surface. The optical waveguide includes a second grating in the not-overlapping portion.

With the above optical device, light incoming from the outside can be efficiently coupled to the optical waveguide through the second grating.

An optical device according to a fifth aspect is featured in that, in the optical device according to any one of the first to fourth aspects, each of the first substrate and the second substrate includes a mirror. The mirror in the first substrate has the first surface. The mirror in the second substrate has the second surface.

With the above optical device, light can propagate in the optical guide layer while being reflected at the first surface of the mirror in the first substrate and at the second surface of the mirror in the second substrate.

An optical device according to a sixth aspect is featured in that, in the optical device according to any one of the first to fifth aspects, the film is a monomolecular film.

With the above optical device, absorption and scattering of light by the monomolecular film is substantially negligible.

An optical device according to a seventh aspect is featured in further including, in the optical device according to any one of the first to sixth aspects, a structure enabling a refractive index of the dielectric member to be adjusted. A direction in which light is emitted from the optical guide layer through the first substrate or the second substrate or an incident direction in which light is taken into the optical guide layer through the first substrate or the second substrate is changeable by changing the refractive index of the dielectric member.

With the above optical device, a light exit direction when the optical device is operated as an optical scanning device and a light receive direction when it is operated as a light receiving device can be changed.

An optical device according to an eighth aspect is featured in further including, in the optical device according to the seventh aspect, a pair of electrodes sandwiching the optical guide layer therebetween. The dielectric member includes a liquid crystal material or an electro-optic material. The refractive index of the dielectric member is changeable by applying a voltage between the pair of electrodes.

With the above optical device, the light exit direction when the optical device is operated as an optical scanning device and the light receive direction when it is operated as a light receiving device can be changed by applying the voltage, through the pair of electrodes, to the dielectric member including the liquid crystal material or the electro-optic material.

An optical device according to a ninth aspect is featured in that, in the optical device according to the eighth aspect, the dielectric member is made of the liquid crystal material. The film is a liquid crystal alignment film in which an alignment direction is defined with rubbing.

With the above optical device, the liquid crystal material can be aligned.

An optical device according to a tenth aspect is featured in that, in the optical device according to the eighth aspect, the dielectric member is made of the liquid crystal material. The film is a liquid crystal alignment film in which an alignment direction is defined with polarized irradiation.

With the above optical device, even when protrusions are present on the first surface and/or the second surface, the liquid crystal material can be aligned on surfaces of the protrusions.

An optical device according to an eleventh aspect is featured in further including, in the optical device according to any one of the first to tenth aspects, phase shifters each connected to the optical guide layer directly or via another waveguide. A direction in which light is emitted from the optical guide layer through the first substrate or the second substrate or an incident direction in which light is taken into the optical guide layer through the first substrate or the second substrate is changed by changing a phase difference between lights passing through the phase shifters.

With the above optical device, the light exit direction when the optical device is operated as an optical scanning device and the light receive direction when it is operated as a light receiving device can be changed with the phase shifters.

An optical detection system according to a twelfth aspect includes the optical device according to any one of the first to eleventh aspects, an optical detector that detects light emitted from the optical device and reflected by an object, and a signal processing circuit that creates distance distribution data based on an output of the optical detector.

With the above optical detection system, a distance measurement image can be created.

An optical fiber according to a thirteenth aspect includes a core extending in a first direction, a film bonded to a surface of the core through a siloxane bond, and a cladding positioned around the core and held in contact with the film, the cladding having a lower refractive index than the core.

With the above optical fiber, since the core and the cladding are bonded with the film interposed therebetween, bonding force between the core and the cladding can be increased.

An optical fiber according to a fourteenth aspect is featured in that, in the optical fiber according to the thirteenth aspect, the film is a monomolecular film.

With the above optical fiber, the bonding force between the core and the cladding can be increased by using the film with good adhesion and high coverage performance.

An optical fiber according to a fifteenth aspect is featured in that, in the optical fiber according to the thirteenth aspect, the core is made of quartz, the cladding is made of acrylic resin, and the film is a monomolecular film containing an alkyl group on an opposite side to the core.

With the above optical fiber, bonding force between the quartz and the acrylic resin can be increased with the monomolecular film containing the alkyl group.

In the present disclosure, all or some of circuits, units, devices, members, or portions, or all or some of functional blocks in a block diagram may be implemented with one or more electronic circuits including, for example, a semiconductor device, a semiconductor integrated circuit (IC), or an LSI (large scale integration). The LSI or the IC may be integrated in one chip or constituted by combining chips with each other. For example, functional blocks except for a storage element may be integrated in one chip. Although the term “LSI” or “IC” is used here, circuits are called in different names depending on a degree of integration, and a circuit called an system LSI, a VLSI (very large scale integration), or an VLSI (ultra large scale integration) may also be used. A Field Programmable Gate Array (FPGA) that is programmed after manufacturing of an LSI, or a reconfigurable logic device enabling connection relationships inside an LSI to be reconfigured or enabling individual circuit sections inside an LSI to be set up can be further used for the same purpose.

Functions or operations of all or some of the circuits, the units, the devices, the members, or the portions can be executed with software processing. In that case, software is recorded on one or more non-temporary recording media such as ROMs, optical disks, or hard disk drives. When software is executed by a processor, functions specified in the software are executed by the processor and peripheral devices. A system or a device may include one or more non-temporary recording media on which software is recorded, a processor, and a required hardware device, for example, an interface.

### First Embodiment

An optical device (optical scanning device 100) according to a first embodiment of the present disclosure may be fabricated by affixing an upper structure body including the mirror 30 and a lower structure body including the mirror 40 to each other. To realize a light scan with application of a voltage, the optical guide layer 20 may contain, for example, a liquid crystal material. Prior to affixing both the structure bodies, an alignment film for aligning the liquid crystal material may be disposed on a surface of the upper structure body and/or a surface of the lower structure body. For example, a sealing member made of ultraviolet curable resin or thermosetting resin may be used to affix the upper structure body and the lower structure body. For example, vacuum sealing may be utilized to inject the liquid crystal material into the optical scanning device 100. With the liquid crystal material injected into a space surrounded by the sealing member, vacuum leakage can be prevented when the liquid crystal material is injected.

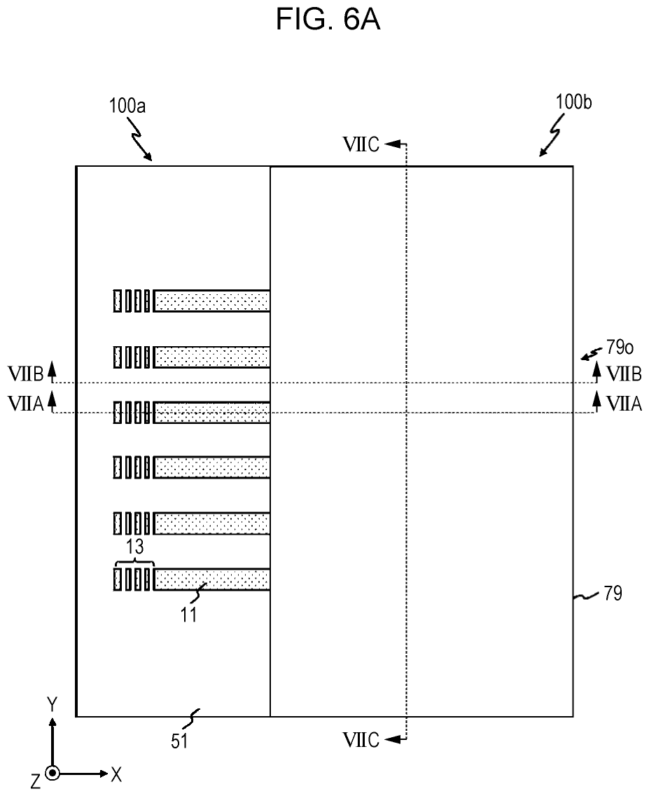

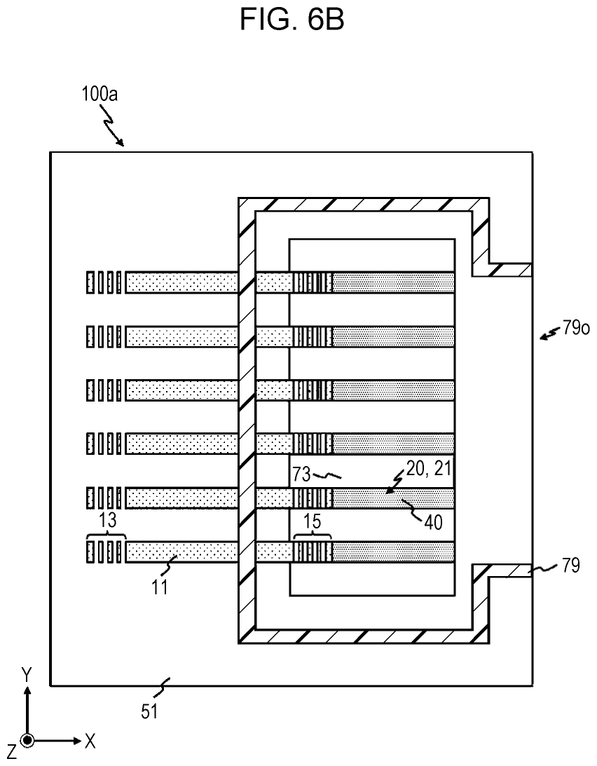

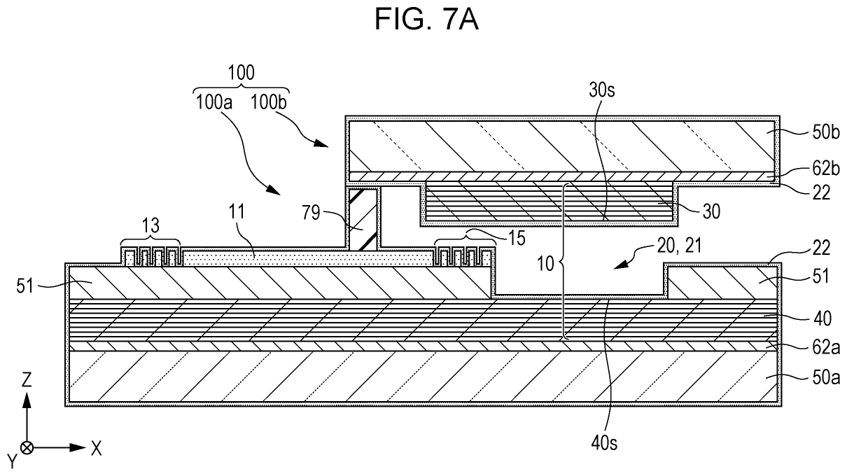

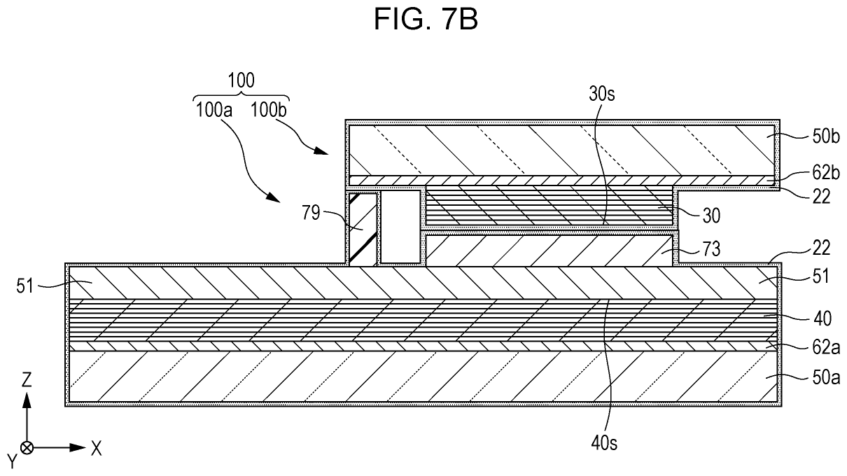

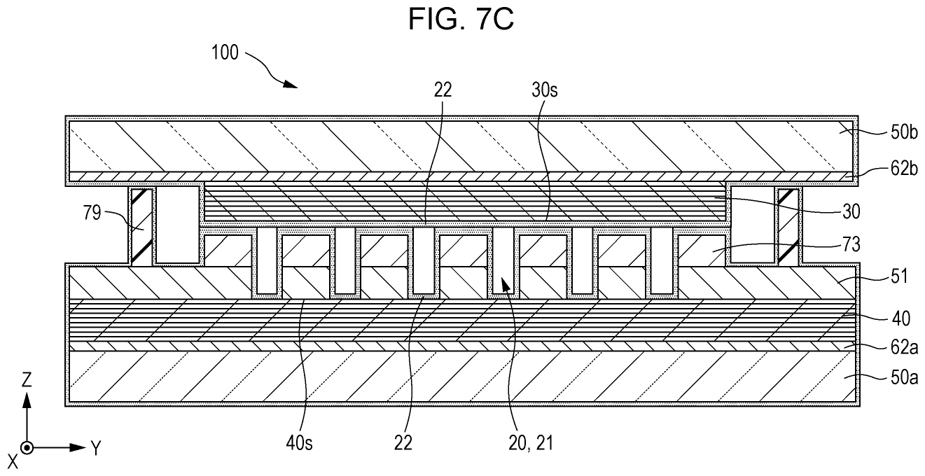

The optical device according to the first embodiment of the present disclosure will be described below with reference to FIGS. 6A to 7C. Matters overlapping those in the above description are omitted in some cases.

FIG. 6A is a schematic view illustrating an example of the optical scanning device 100 according to the first embodiment of the present disclosure when viewed from the Z-direction. In FIG. 6A, the alignment film is omitted. FIG. 6B illustrates the optical scanning device 100 of FIG. 6A from which an upper structure body 100b is omitted. FIGS. 7A, 7B, and 7C are sectional views taken along line VIIA-VIIA, line and line VIIC-VIIC in FIG. 6A, respectively.

In the example illustrated in FIGS. 7A to 7C, the optical scanning device 100 according to this embodiment includes a first substrate 50a, a second substrate 50b, partition walls 73, first optical waveguides (waveguide elements) 10, second optical waveguides (optical waveguides) 11, a sealing member 79, and a film 22. The number of the first optical waveguides 10 is not limited to a specific value and may be one. This is similarly applied to the number of the second optical waveguides 11. In the following description, “first” and “second” are omitted. The optical scanning device 100 according to this embodiment can be divided into the lower structure body 100a, the upper structure body 100b, and the film 22. It is to be noted that the words “upper” and “lower” are not purported to restrict a layout posture of the optical scanning device 100.

In the example illustrated in FIGS. 7A to 7C, the lower structure body 100a includes the substrate 50a, an electrode 62a, the mirror 40, a dielectric layer 51, the partition walls 73, the sealing member 79, and the optical waveguides 11. The electrode 62a is disposed on the substrate 50a. The mirror 40 is disposed on the electrode 62a. The dielectric layer 51 is disposed on the mirror 40. The partition walls 73, the sealing member 79, and the optical waveguides 11 are disposed on the dielectric layer 51. It can also be said that the substrate 50a includes the mirror 40.

In the example illustrated in FIGS. 7A to 7C, the upper structure body 100b includes the substrate 50b, an electrode 62b, and the mirror 30. The electrode 62b is disposed on the substrate 50b. The mirror 30 is disposed on the electrode 62b. The reflecting surface 30s of the mirror 30 and the reflecting surface 40s of the mirror 40 face each other. It can also be said that the substrate 50b includes the mirror 30.

In the example illustrated in FIGS. 7A to 7C, the film 22 is disposed on an uppermost surface, a lowermost surface, and outermost side surfaces of the lower structure body 100a. The film 22 is disposed on parts of surfaces of the substrate 50a, the mirror 40, the dielectric layer 51, the partition walls 73, the sealing member 79, and the optical waveguides 11, those parts being exposed if the film 22 is not present. Similarly, the film 22 is disposed an uppermost surface, a lowermost surface, and outermost side surfaces of the upper structure body 100b. The film 22 is disposed on parts of surfaces of the substrate 50b, the mirror 30, and the electrode 62b, those parts being exposed if the film 22 is not present.

The configuration of the optical scanning device 100 will be described in detail below.

Of the substrate 50a and the substrate 50b, the substrate on a light exit side has optical transparency. Both the substrate 50a and the substrate 50b may have optical transparency. Similarly, of the electrode 62a and the electrode 62b, the electrode on the light exit side has optical transparency. Both the electrode 62a and the electrode 62b may have optical transparency. At least one of the electrode 62a or the electrode 62b may be formed as, for example, a transparent electrode. In the example illustrated in FIGS. 7A to 7C, light is emitted from each optical waveguide 10 through the electrode 62b and the substrate 50b of the upper structure body 100b.

The partition walls 73 are arrayed in the Y-direction and are positioned between the substrate 50a and the substrate 50b. The partition walls 73 extend in the X-direction.

The optical waveguides 10 are each defined between adjacent two of the partition walls 73. Each of the optical waveguides 10 includes the mirror 30, the mirror 40, and the optical guide layer 20. In the example illustrated in FIGS. 6B to 7C, part of the dielectric layer 51 is removed such that part of the mirror 40 is exposed. The optical guide layer 20 is disposed in a region surrounded by the mirror 30, the exposed part of the mirror 40, and the adjacent two of the partition walls 73. The optical guide layer 20 includes a dielectric member 21. The dielectric member 21 contains, for example, a liquid crystal material or an electro-optic material. The optical waveguide 10 functions as the above-described slow light waveguide. The mirror 30 is positioned between the substrate 50b and the optical guide layer 20. The mirror 40 is positioned between the substrate 50a and the optical guide layer 20.

The optical guide layer 20 has a higher refractive index than the partition walls 73 and the dielectric layer 51. Therefore, light propagating in the optical guide layer 20 does not leak to the partition walls 73 and the dielectric layer 51 that exists just under the optical guide layer 20. The light propagating in the optical guide layer 20 is totally reflected at an interface between the optical guide layer 20 and each partition wall 73 and at an interface between the optical guide layer 20 and the dielectric layer 51.

The electrode 62a and the electrode 62b directly or indirectly sandwich the dielectric member 21. The wording “directly sandwich” indicates that both the electrodes sandwich the dielectric member 21 with any other member not interposed therebetween. The wording “indirectly sandwich” indicates that both the electrodes sandwich the dielectric member 21 with any other member interposed therebetween. By applying a voltage between the electrode 62a and the electrode 62b, the refractive index of the dielectric member 21 is adjusted. As a result, an exit angle of light emitted from the optical waveguide 10 to the outside is changed.

The optical waveguide 10 is not always required to be the slow light waveguide. For example, the optical waveguide 10 may be an optical waveguide that does not include the mirror 30 and the mirror 40 and that causes light to propagate in the optical guide layer 20 while repeating total reflection at a surface of the substrate 50a and a surface of the substrate 50b. In such an optical waveguide, the light is emitted to the outside from an end portion of the optical waveguide 10 without passing through the substrate 50a or the substrate 50b.

The sealing member 79 fixedly holds a distance between the substrate 50a and the substrate 50b. As illustrated in FIG. 6B, the sealing member 79 surrounds the optical waveguides 10 and the partition walls 73 when viewed from the Z-direction. The sealing member 79 is disposed to extend in the Y-direction while straddling the optical waveguides 11. An upper surface of the sealing member 79 is parallel to the XY plane. A size of the sealing member 79 in the Z-direction above the dielectric layer 51 is equal to or greater than a total of a size of the partition walls 73 and a size of the mirror 30 in the Z-direction. The sealing member 79 may be made of, for example, ultraviolet curable resin or thermosetting resin. A material of the sealing member 79 is not always required to be the ultraviolet curable resin or the thermosetting resin insofar as the material can maintain the distance between the substrate 50a and the substrate 50b for a long period.

The optical waveguide 11 is connected to the optical waveguide 10. Light is supplied from the optical waveguide 11 to the optical waveguide 10. In the example illustrated in FIGS. 6A to 7C, the optical waveguide 11 is positioned on the dielectric layer 51. The dielectric layer 51 is positioned between the substrate 50a and the optical waveguide 11. By adjusting the size of the dielectric layer 51 in the Z-direction, the light propagating through the optical waveguide 11 can be coupled to the optical waveguide 10 with high efficiency. The size of the dielectric layer 51 in the Z-direction may be adjusted, for example, such that the optical waveguide 11 is poisoned near a center of the optical guide layer 20 in the Z-direction. The optical waveguide 11 is a waveguide through which light is to be propagated with total reflection. To that end, the optical waveguide 11 has a higher refractive index than the dielectric layer 51. The optical waveguide 11 may be a slow light waveguide.

Each of the optical waveguides 11 includes a portion positioned between adjacent two of the partition walls 73. As illustrated in FIGS. 6B to 7C, each of the optical waveguides 11 may include a grating 15 in the above-mentioned portion. A propagation constant of the optical waveguide 11 is different from that of the optical waveguide 10. The propagation constant of the optical waveguide 11 is shifted by the grating 15 through an amount corresponding to a reciprocal lattice. When the propagation constant of the optical waveguide 11 having been shifted through the amount corresponding to the reciprocal lattice matches with the propagation constant of the optical waveguide 10, the light propagating through the optical waveguide 11 is coupled to the optical waveguide 10 with high efficiency.

When the dielectric member 21 is made of the liquid crystal material, the liquid crystal material is injected through a filling port 79o, illustrated in FIG. 6B, after the lower structure body 100a and the upper structure body 100b have been affixed to each other. After injecting the liquid crystal material, the filling port 790 is closed with the same member as the sealing member 79. A space enclosed as described above is entirely filled with the liquid crystal material. The space is positioned between the substrate 50a and the substrate 50b and is surrounded by the sealing member 79. The space is filled with the same material as the dielectric member 21.

The film 22 in this embodiment will be described below. The film 22 in this embodiment is a monomolecular film bonded, through a siloxane bond, to a surface on which the film 22 is disposed. The siloxane bond is advantageous in not only increasing adhesion and coverage performance of the monomolecular film, but also being lower in cost. The film 22 is disposed on at least the reflecting surface 30s of the mirror 30 and/or the reflecting surface 40s of the mirror 40. In the example illustrated in FIGS. 7A to 7C, although the film 22 is disposed on other surfaces as well than the reflecting surface 30s and/or the reflecting surface 40s for convenience in fabrication of the optical scanning device 100, the film 22 is not always required to be disposed on those other surfaces.

The monomolecular alignment film is thinner and more uniform in thickness than the polyimide alignment film. The thickness of the monomolecular alignment film is about 2 nm, namely a molecule size. Even with light being incident on the thin and uniform monomolecular alignment film, absorption and scattering of the light hardly occurs. Accordingly, when light propagates in the optical guide layer 20 in the X-direction with multiple reflections as illustrated in FIG. 2, the light is hardly absorbed and scattered by the monomolecular alignment film. As a result, light loss in the optical guide layer 20 can be suppressed.

Because the thin film 22 does not function as an insulating film, there is no problem even if the film 22 disposed on the other surfaces than the reflecting surface 30s and/or the reflecting surface 40s is left there. Accordingly, a step of removing the film 22 can be omitted in the fabrication of the optical scanning device 100. Depending on applications, the film 22 disposed on the other surfaces than the reflecting surface 30s and/or the second reflecting surface 40s may be removed.

Details of materials and sizes of components used in the fabrication of the optical scanning device 100 according to this embodiment will be described below. In the following description, the size in the Z-direction is referred to as a “thickness” in some cases.

Examples of materials and sizes of components of the lower structure body 100a are first described.

The substrate 50a may be formed of, for example, an SiO₂ layer. The sizes of the substrate 50a in the X-direction and the Y-direction may be, for example, each 15 mm. The thickness of the substrate 50a may be, for example, 0.7 mm.

The electrode 62a may be formed of, for example, an ITO sputtered layer. The thickness of the electrode 62a may be, for example, 50 nm.

The mirror 40 may be a multilayer reflecting film. The multilayer reflecting film may be formed, for example, by alternately vapor-depositing an Nb₂O₅ layer and an SiO₂ layer to be laminated one above another. The Nb₂O₅ layer has a refractive index n=2.282. The thickness of the Nb₂O₅ layer may be, for example, about 100 nm. The SiO₂ layer has a refractive index n=1.468. The thickness of the SiO₂ layer may be, for example, about 200 nm. The mirror 40 includes, for example, thirty-one Nb₂O₅ layers and thirty SiO₂ layers, namely sixty-one layers in total. The thickness of the mirror 40 may be, for example, 9.1 μm.

The dielectric layer 51 may be formed of, for example, an Sift vapor-deposited layer. The SiO₂ vapor-deposited layer has a refractive index n=1.468. The thickness of the SiO₂ vapor-deposited layer may be, for example, about 1.0 μm.

The optical waveguide 11 may be formed of, for example, an Nb₂O₅ vapor-deposited layer. The Nb₂O₅ vapor-deposited layer has a refractive index n=2.282. The thickness of the Nb₂O₅ vapor-deposited layer may be, for example, about 300 nm. The gratings 15 and 13 may be formed in the optical waveguide 11. The grating 15 has a duty ratio of 1:1 and a pitch of 640 nm, for example. The grating 13 has a duty ratio of 1:1 and a pitch of 680 nm, for example. The gratings 15 and 13 may be formed by patterning with photolithography. The size of the optical waveguide 11 in the Y-direction may be, for example, 10 μm.

The partition walls 73 may be each formed of, for example, an SiO₂ vapor-deposited layer. The SiO₂ vapor-deposited layer has a refractive index n=1.468. The thickness of the SiO₂ vapor-deposited layer may be, for example, about 1.0 μm. The size of the partition wall 73 in the Y-direction may be, for example, 50 μm.

In the optical guide layer 20, part of the dielectric layer 51 may be removed by, for example, patterning with photolithography. The thickness of the optical guide layer 20 may be, for example, 2.0 μm. The size of the optical guide layer 20 in the Y-direction may be, for example, 10 μm.

Details of materials and sizes of components of the upper structure body 100b are described below.

The substrate 50b may be formed of, for example, an SiO₂ layer. The sizes of the substrate 50b in the X-direction and the Y-direction may be, for example, 8 mm and 20 mm, respectively. The thickness of the substrate 50b may be, for example, 0.7 mm.

The electrode 62b may be formed of, for example, an ITO sputtered layer. The thickness of the electrode 62b may be, for example, 50 nm.

The mirror 30 may be a multilayer reflecting film. The multilayer reflecting film may be formed, for example, by alternately vapor-depositing an Nb₂O₅ layer and an SiO₂ layer to be laminated one above another. The Nb₂O₅ layer has a refractive index n=2.282. The thickness of the Nb₂O₅ layer may be, for example, about 100 nm. The SiO₂ layer has a refractive index n=1.468. The thickness of the SiO₂ layer may be, for example, about 200 nm. The mirror 30 includes, for example, seven Nb₂O₅ layers and six

SiO₂ layers, namely thirteen layers in total. The thickness of the mirror 30 may be, for example, 1.9 μm.

A 5CB liquid crystal is used for the dielectric member 21. A material of the film 22 and a method of disposing the film 22 will be described later.

An Ultraviolet Curable Adhesive 3026E made by ThreeBond Co., Ltd. is used for the sealing member 79. The sealing member 79 is cured with ultraviolet irradiation at a wavelength of 365 nm and an energy density of 100 mJ/cm², whereby the lower structure body 100a and the upper structure body 100b each including the film 22 are affixed to each other. With the affixing, the optical scanning device 100 according to this embodiment is obtained.

The substrate 50a and the substrate 50b are not always required to be made of SiO₂. The substrate 50a and the substrate 50b may be each, for example, an inorganic substrate made of glass or sapphire, or a resin substrate made of acrylic or polycarbonate. The inorganic substrate and the resin substrate have optical transparency.

The light transmittance of the mirror 30 from which light is emitted is, for example, 99.9%, and the light transmittance of the mirror 40 from which light is not emitted is, for example, 99.99%. Those conditions can be realized by adjusting the number of layers in the multilayer reflecting film in each mirror. A combination of two layers in the multilayer reflecting film is, for example, that the refractive index of one layer is more than or equal to 2 and the refractive index of the other layer is less than 2. By setting the difference between the two refractive indexes to be large, a high reflectance can be obtained. The layer with the refractive index of more than or equal to 2 is made of at least one selected from the group consisting of, for example, SiNx, AlNx, TiOx, ZrOx, NbOx, and TaOx. The layer with the refractive index of less than 2 is made of, for example, at least one selected from the group consisting of SiOx and AlOx.

The reflective index of the dielectric layer 51 is, for example, less than 2, and the reflective index of each optical waveguide 11 is, for example, more than or equal to 2. By setting the difference between the two refractive indexes to be large, evanescent light seeping out from each optical waveguide 11 to the dielectric layer 51 can be reduced.

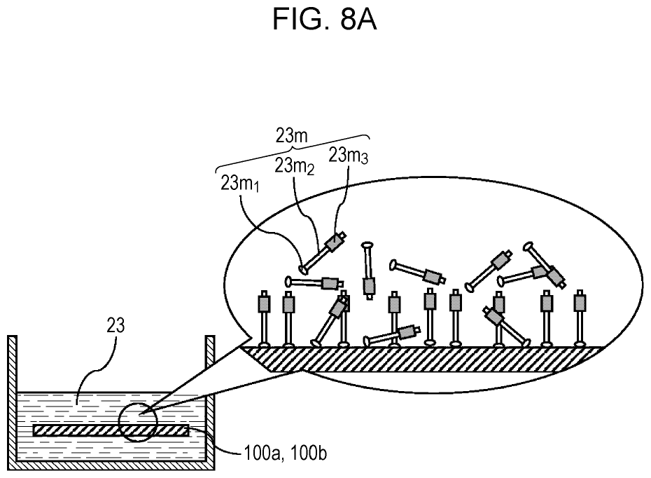

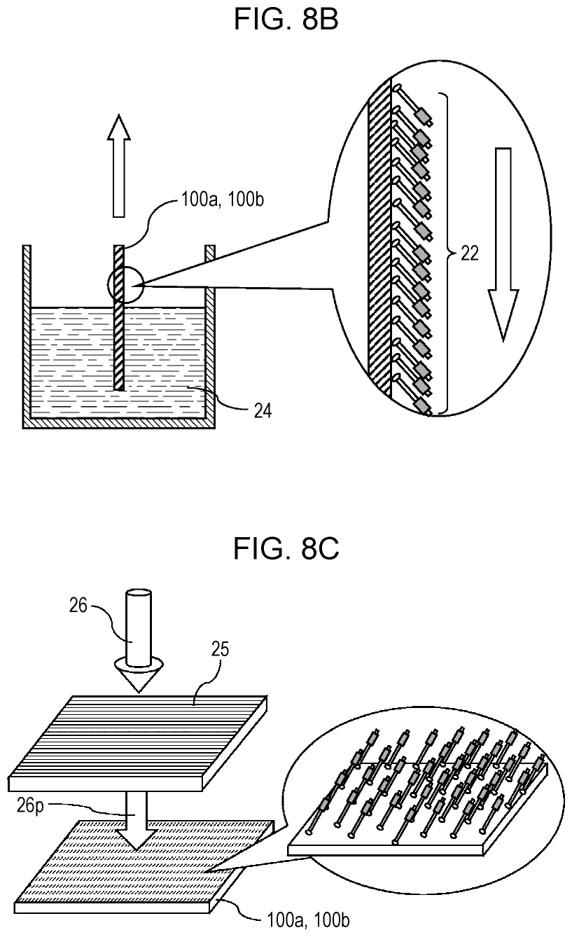

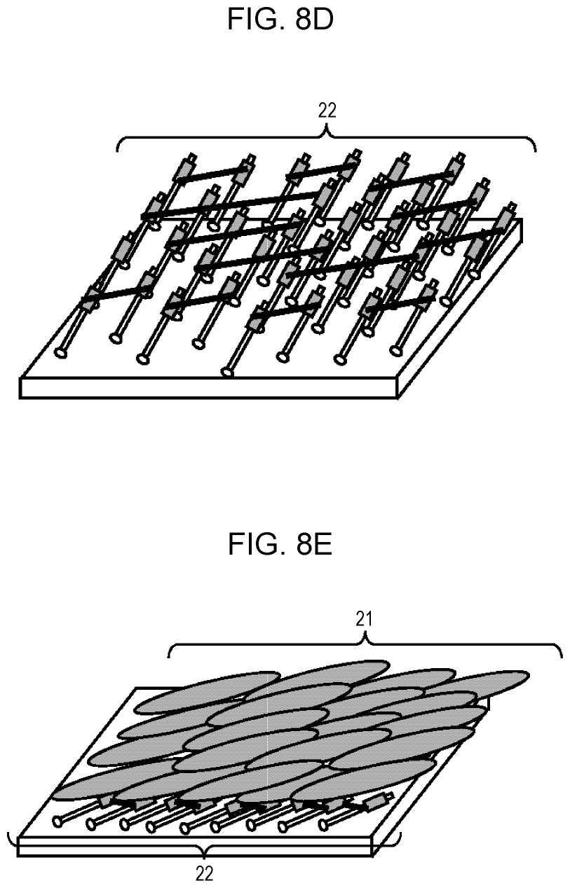

The material of the film 22 in this embodiment and the method of disposing the film 22 will be described below with reference to FIGS. 8A to 8E. FIGS. 8A to 8E are explanatory views illustrating the film 22 in this embodiment.

As illustrated in FIG. 8A, a solution 23 containing at least a silane compound is brought into contact with the lower structure body 100a and/or the upper structure body 100b, thus causing the silane compound to be chemically adsorbed on the structure body. As a result, a film bonded through a siloxane bond is formed. In a molecule 23m illustrated in FIG. 8A, an elliptic portion 23m₁ represents the siloxane bond, a thin and long portion 23m₂ represents a carbon-hydrogen bond, and a thick and short portion 23m₃ represents other bonds.

Then, as illustrated in FIG. 8B, the excessive silane compound not chemically adsorbed is dissolved into a cleaning liquid 24 and is removed. As a result, the above-mentioned film becomes a monomolecular film 22 bonded through the siloxane bond.

A method of aligning the monomolecular film 22 is as follows. The monomolecular film 22 can be aligned, as illustrated in FIG. 8B, by draining the cleaning liquid 24 off. An arrow facing upward represents a direction in which the lower structure body 100a and/or the upper structure body 100b are lifted up, and an arrow facing downward represents an alignment direction. Alternatively, when the monomolecular film 22 bonded through the siloxane bond contains a photosensitive group, the photosensitive group is cross-linked or polymerized as illustrated in FIG. 8D by, as illustrated in FIG. 8C, irradiating the monomolecular film 22 with polarized light 26p that is obtained by causing a non-polarized ultraviolet ray 26 to pass through a polarizer 25. In FIG. 8D, a thick line represents cross-linking. Thus, the monomolecular film 22 becomes a monomolecular alignment film exhibiting uniform alignment anisotropy for a liquid crystal. As an alternative, the monomolecular film 22 is turned to the monomolecular alignment film exhibiting the uniform alignment anisotropy by rubbing a surface of the monomolecular film bonded through the siloxane bond.

Whether an alignment process for the monomolecular alignment film has been performed with polarized irradiation or rubbing can be known depending on whether there are scratches on the monomolecular alignment film. The polarized irradiation causes no scratches on the monomolecular alignment film. On the other hand, the rubbing causes the scratches on the monomolecular alignment film.

As illustrated in FIG. 8E, a liquid crystal material 21 made up of rod-like molecules is aligned in a particular direction by the monomolecular alignment film 22.

The above-described solution 23 containing the silane compound indicates a solution that the silane compound is dissolved in a solvent (or a dissolvent). However, the solution 23 may be in a state in which part of the silane compound is not dissolved. A typical example of that type of solution is a solution in a supersaturated state.

Specific examples of the silane compound, which can be used in the above-described method of fabricating the film 22, are listed in (1) to (5) given below.

SiYₚCl₃₋ₚ (1)

CH₃—(CH₂)ᵣSiY_{q}Cl_{3-q} (2)

CH₃(CH₂)ₛO(CH₂)ₜSiY_{q}Cl_{3-q} (3)

CH₃(CH₂)ᵤ—Si(CH₃)₂(CH₂)ᵥSiY_{q}Cl_{3-q} (4)

CF₃COO(CH₂)_{w}SiY_{q}Cl_{3-q} (5)

In the above formulae, p denotes an integer from 0 to 3, q denotes an integer from 0 to 2, r denotes an integer from 1 to 25, s denotes an integer from 0 to 12, t denotes an integer from 1 to 20, u denotes an integer from 0 to 12, v denotes an integer from 1 to 20, and w denotes an integer from 1 to 25. Y denotes one selected from the group consisting of hydrogen, an alkyl group, an alkoxyl group, a fluorine-containing alkyl group, and a fluorine-containing alkoxyl group.

Specific examples of a trichlorosilane compound are listed in (6) to (14) given below.

CF₃(CH₂)₉SiCl₃ (6)

CH₃(CH₂)₉OSiCl₃ (7)

CH₃(CH₂)₉Si(CH₃)₂(CH₂)₁₀SiCl₃ (8)

CH₃COO(CH₂)₁₅SiCl₃ (9)

CF₃(CF₂)₇—(CH₂)₂—SiCl₃ (10)

CF₃(CF₂)₇—C₆H₄—SiCl₃ (11)

C₆H₅—CH═CH—CO—O—(CH₂)₆—O—SiCl₃ (12)

C₆H₅—CO—CH═CH—C₆H₄—O—(CH₂)₆—O—SiCl₃ (13)

C₆H₅—CH═CH—CO—C₆H₄—O—(CH₂)₆—O—SiCl₃ (14)

The compound (12) has a photosensitive cinnamoyl group. The compounds (13) and (14) each have a photosensitive chalconyl group. Photosensitive group portions are polymerized upon irradiation with an ultraviolet ray. Furthermore, an isocyanate silane compound obtained by replacing a chlorosilyl group with an isocyanate group, or an alkoxy silane compound obtained by replacing a chlorosilyl group with an alkoxy group may be used instead of the above-described chlorosilane compound.

For example, an isocyanate silane compound (15) or an alkoxy silane compound (16), given below, may be used instead of the chlorosilane (6).

CH₃(CH₂)₉Si(OC₂H₅)₃ (15)

CH₃(CH₂)₉Si(NCO)₃ (16)

Using the isocyanate silane compound or the alkoxy silane compound is advantageous in that, because no hydrochloric acid is generated with chemical bonding, a device is not damaged, and work is easier to perform.

A process of forming a thin film on a substrate surface with a silane compound and a solvent and a substrate used in the process will be described below.

The following chemical formula (1) represents reaction steps when the compound CF₃—(CF₂)₇—(CH₂)₂—SiCl₃ denoted in above (10) is used as the silane compound and is brought into contact with a glass substrate.

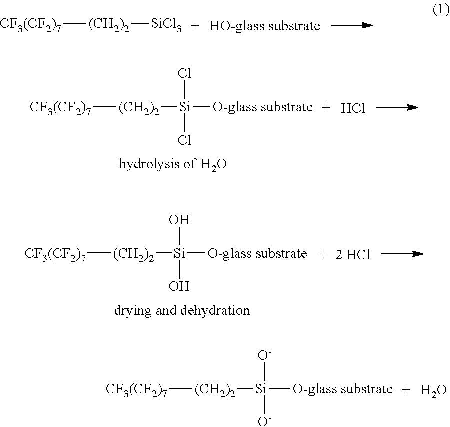

A first dehydrochlorination reaction denoted in the chemical formula (1) is a chemical adsorption reaction. When a silane compound solution is brought into contact with the glass substrate having an OH group, the dehydrochlorination reaction occurs. With the dehydrochlorination reaction, one end of the silane compound is chemically bonded to an OH group portion in a substrate surface. That reaction a reaction between a SiCl group in the silane compound and the OH group. When the silane compound solution contains a large amount of water, the reaction with the substrate is impeded. To smoothly promote the reaction, therefore, it is desired to use a nonaqueous solvent not containing active hydrogen such as the OH group and to progress the reaction in an atmosphere with low humidity. Details of a humidity condition will be described later. Thereafter, through hydrolysis of H₂O, drying, and dehydration, the film bonded through the siloxane bond is formed on the surface of the glass substrate.

A solvent capable of being used in this embodiment for the silane compound may be, for example, at least one selected from the group consisting of a hydrocarbon solvent, a carbon fluoride solvent, and a silicone solvent each containing no water. A petroleum solvent capable of being used in this embodiment may be, for example, at least one selected from the group consisting of petroleum naphtha, solvent naphtha, petroleum ether, petroleum benzine, isoparaffin, normal paraffin, decalin, industrial gasoline, kerosene, ligroin, dimethyl silicone, phenyl silicone, alkyl-denatured silicone, and polyester silicone. The carbon fluoride solvent capable of being used in this embodiment may be at least one selected from the group consisting of a freon solvent, Fluorinert (made by 3M Company), and Afluid (made by Asahi Glass Co., Ltd.). The above-mentioned solvents may be used alone or in a combination of two or more that are compatible with each other.

Particularly, silicone contains very little water and is less hygroscopic. Moreover, the silicone is solvated with the chlorosilane compound and acts to prevent the chlorosilane compound from coming into direct contact with water. Accordingly, by bringing a solution of the chlorosilane compound and the silicone into contact with an underlying layer, the chlorosilane compound can be chemically adsorbed on the OH group exposed to the underlying layer while an adverse effect of moisture in an ambient atmosphere is prevented.

In consideration of that the film 22 is to be disposed, the optical waveguide 11, the mirror 30, the mirror 40, the dielectric layer 51, and the partition wall 73 in the optical scanning device 100 may be made of materials given below. Among those materials, the material with a reflective index of more than or equal to 2 is at least one selected from the group consisting of SiNx, AlNx, TiOx, ZrOx, NbOx, and TaOx. Among those materials, the material with a reflective index of less than 2 is at least one selected from the group consisting of SiOx and AlOx. The above-mentioned materials can provide many OH groups serving as adsorption sites for the silane compounds. Accordingly, the alignment film with a good alignment characteristic can be formed on surfaces of those materials.

On the other hand, the electrode 62a and the electrode 62b in the optical scanning device 100 may be made of at least one conductive material selected from the group consisting of ITO and Al. The sealing member 79 in the optical scanning device 100 may be made of, for example, an acrylic or silicone polymer material. The above-mentioned conductive materials and polymer materials contain few OH groups serving as the adsorption sites for the silane compounds. Therefore, when the alignment film is to be formed on surfaces of the above-mentioned materials, hydrophilization for producing or increasing the OH groups are carried on those surfaces. As the hydrophilization, it is effective to form an SiO₂ film or an SiNₓ film on the surfaces, or to produce the OH groups with UV-O₃ treatment.

When protrusions on surfaces of the lower structure body 100a and/or the upper structure body 100b have heights of more than or equal to 40 nm, unevenness attributable to the protrusions occurs with the rubbing. In a structure body including integral protrusions, the protrusions may have height of 50 μm in some cases. Those protrusions may be broken with the rubbing. On the other hand, with the polarized irradiation, the alignment direction can be defined even in a portion where the protrusions are positioned adjacent to each other or intersect. In addition, the protrusions are not broken. The polarized irradiation is effective for protrusions in arbitrary shapes except for a reverse-tapered shape.

For example, dipping and vapor cleaning are used as cleaning methods in this embodiment. Particularly, the vapor cleaning can strongly remove, with osmotic power, the excessive silane compounds that are not adsorbed in all the surfaces of the lower structure body 100a and/or the upper structure body 100b. A cleaning solvent capable of being used in this embodiment may be, for example, at least one selected from the group consisting of a hydrocarbon solvent, a carbon fluoride solvent, and a silicone solvent each containing no water. A petroleum cleaning solvent capable of being used in this embodiment may be, for example, at least one selected from the group consisting of petroleum naphtha, solvent naphtha, petroleum ether, petroleum benzine, isoparaffin, normal paraffin, decalin, industrial gasoline, kerosene, ligroin, dimethyl silicone, phenyl silicone, alkyl-denatured silicone, and polyester silicone. The carbon fluoride solvent capable of being used in this embodiment may be at least one selected from the group consisting of a freon solvent, Fluorinert (made by 3M Company), and Afluid (made by Asahi Glass Co., Ltd.). The above-mentioned solvents (or dissolvents) may be used alone or in a combination of two or more that are compatible with each other.

As an alignment method with draining in this embodiment, there is a method of, as illustrated in FIG. 8B, holding the surfaces of the lower structure body 100a and/or the upper structure body 100b to stand in a vertical direction and draining the cleaning liquid off. This enables the cleaning liquid to be drained off only in the vertical direction. Particularly, the draining-off of the cleaning liquid with the boiling point of lower than or equal to 200° C. is superior in drying property after the draining. Furthermore, chloroform is superior in performance of removing a chlorosilane polymer that is generated with a reaction between chlorosilane and water.

As the alignment method with draining in this embodiment, there is also a method of spraying gas to the surfaces of the lower structure body 100a and/or the upper structure body 100b and draining the cleaning liquid off. This enables the cleaning liquid to be drained off in a short time only in a direction in which the gas is sprayed. Particularly, in the draining-off of the cleaning liquid with the boiling point of higher than or equal to 150° C., the cleaning liquid is not evaporated even with the spraying of the gas. Furthermore, N-methyl-2pyrrolidinone is superior in performance of removing the chlorosilane polymer that is generated with the reaction between chlorosilane and water.

A polarized ultraviolet ray used in the alignment with the polarized irradiation applicable to this embodiment may have a wavelength distribution of longer than or equal to about 300 nm and shorter than or equal to about 400 nm. An irradiation dose of the polarized ultraviolet ray is greater than or equal to about 50 mJ/cm² and smaller than or equal to about 2000 mJ/cm² at 365 nm. Particularly, at the irradiation dose of greater than or equal to 1000 mJ/cm², the alignment of the liquid crystal material tends to become homogeneous alignment. On the other hand, at the irradiation dose of smaller than 100 mJ/cm², the alignment of the liquid crystal material tends to become pre-tilt alignment.

The result of measuring the light emitted from the optical scanning device 100 according to this embodiment will be described below.

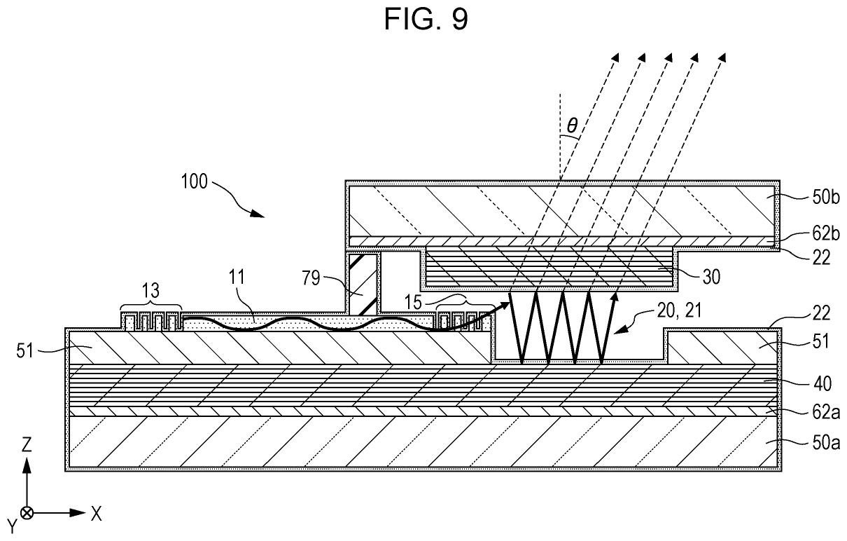

FIG. 9 is a schematic view illustrating exiting of the light from the optical scanning device 100. In the example illustrated in FIG. 9, the light emitted from the optical scanning device 100 was measured with an optical detector (not illustrated) that is fixedly held in a direction of an exit angle θ=60°. In the measurement, a laser beam of 589 nm was input to each optical waveguide 11 through the grating 13. When the film 22 was the monomolecular alignment film with the siloxane bond, intensity of the measured light was substantially doubled in comparison with the case in which the film 22 was a polyimide alignment film. In other words, it was confirmed that, when the polyimide alignment film was used, light loss was about 50%.

The polyimide alignment film is often used in a liquid crystal display. In the liquid crystal display, light passes through alignment films disposed on upper and lower substrates only once. Accordingly, even when the thick and nonuniform polyimide alignment film is used, the light loss caused by absorption and scattering in the alignment film does not really raise the problem with one passage of the light.

In the optical scanning device 100 according to this embodiment, as described above, light propagates in the optical guide layer 20 while being reflected multiple times at the reflecting surface 30s and the reflecting surface 40s each including the film 22. Accordingly, when the polyimide alignment film is used, the light loss caused by absorption and scattering in the alignment film is increased. On the other hand, in the case of using the monomolecular alignment film that is as thin as the molecule size and is uniform, even when light is reflected multiple times, the light loss caused by absorption and scattering in the alignment film is negligible. As a result, intensity of the light can be greatly increased because of reduction in the light loss.

In the above-described example, the partition walls 73 are arranged between the mirror 30 and the mirror 40. A planar optical waveguide including the mirror 30, the mirror 40, and the optical guide layer 20 may be connected to the optical waveguides 11 without disposing the partition walls 73. Lights propagating through the optical waveguides 11 interfere with each other inside the optical guide layer 20 in the planar optical waveguide, thereby forming a light beam. The light beam formed inside the optical guide layer 20 is emitted to the outside through the mirror 30 and the substrate 50b.

### Application Examples

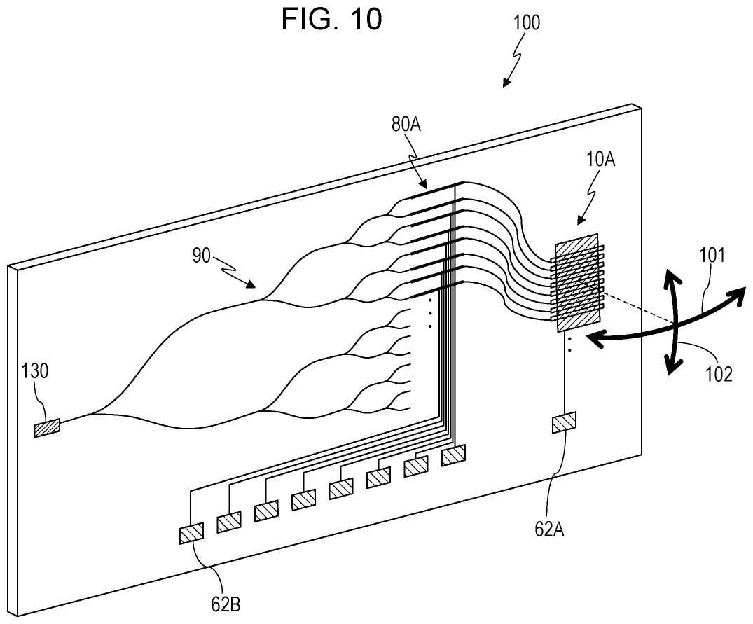

FIG. 10 illustrates an example of configuration of the optical scanning device 100 in which individual elements, such as the optical demultiplexer 90, the waveguide array 10A, the phase shifter array 80A, and a light source 130, are integrated on a circuit board (for example, a chip). The light source 130 may be, for example, a light emitting element such as a semiconductor laser. The light source 130 in the illustrated example emits light of a single wavelength, the light having a wavelength λ in a free space. The optical demultiplexer 90 demultiplexes the light from the light source 130 and introduces the demultiplexed lights to waveguides in the phase shifters. In the example illustrated in FIG. 10, one electrode 62A and multiple electrodes 62B are disposed on the chip. A control signal is supplied from the electrode 62A to the waveguide array 10A. Control signals are supplied from the electrodes 62B to the phase shifters 80 in the phase shifter array 80A. The electrode 62A and the electrodes 62B may be connected to a control circuit (not illustrated) that generates the above-mentioned control signals. The control circuit may be disposed on the chip illustrated in FIG. 10 or on another chip in the optical scanning device 100.

With all components integrated on one chip as illustrated in FIG. 10, a light scan over a wide range can be realized with a small device. All the components illustrated in FIG. 10 can be integrated on a chip with a size of about 2 mm×1 mm, for example.

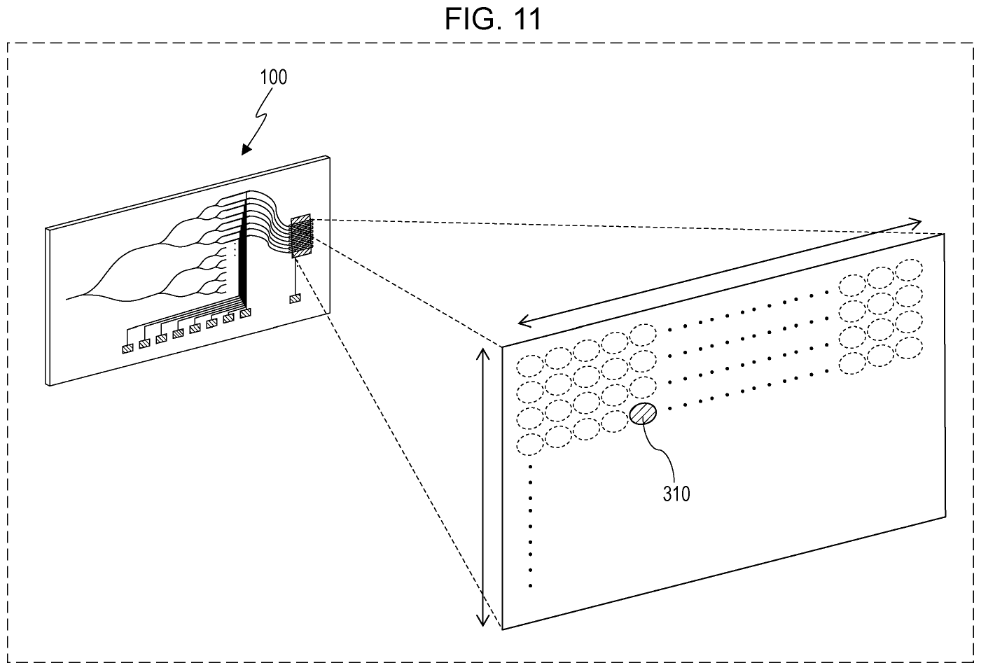

FIG. 11 is a schematic view illustrating a situation in which a two-dimensional scan is performed by emitting a light beam, such as a laser, to a far field from the optical scanning device 100. The two-dimensional scan is performed by moving a beam spot 310 in the horizontal and vertical directions. For example, a two-dimensional distance measurement image can be obtained by combining the optical scanning device 100 with a known TOF (Time Of Flight) method. The TOF method is a method of emitting the laser to an object, observing reflected light from the object, calculating a flight time of the light, and determining a distance to the object.

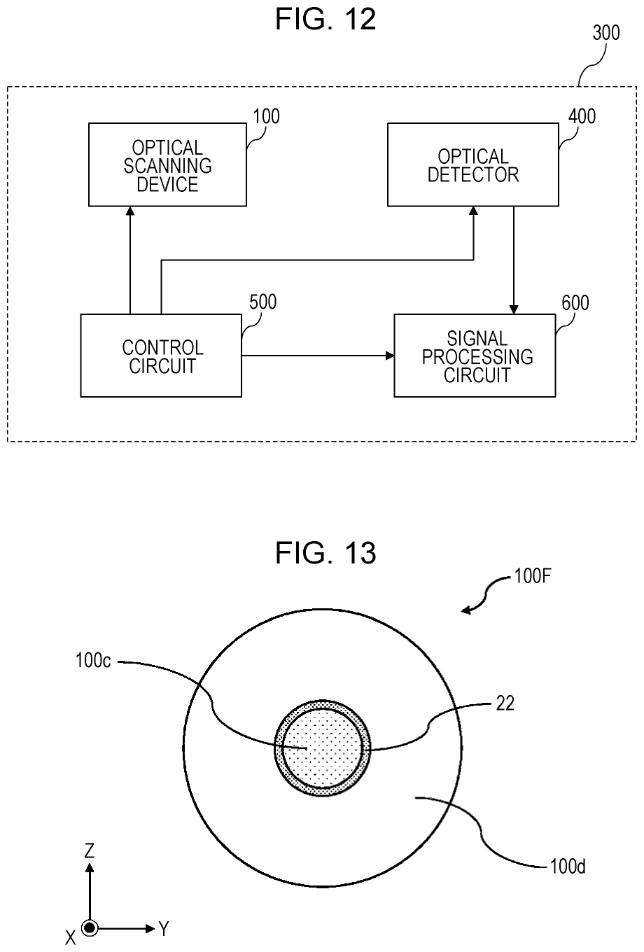

FIG. 12 is a block diagram illustrating an example of configuration of a LiDAR system 300 that is an example of an optical detection system capable of creating the above-described distance measurement image. The LiDAR system 300 includes the optical scanning device 100, an optical detector 400, a signal processing circuit 600, and a control circuit 500. The optical detector 400 detects the light emitted from the optical scanning device 100 and reflected from the object. The optical detector 400 may be a photodetector including a light receiving element, such as an image sensor or a photodiode, with sensitivity for the wavelength λ of the light emitted from the optical scanning device 100. The optical detector 400 outputs an electric signal corresponding to an amount of the received light. The signal processing circuit 600 calculates the distance to the object based on the electric signal output from the optical detector 400 and creates distance distribution data. The distance distribution data is data representing a two-dimensional distribution of the distance (namely, a distance measurement image). The control circuit 500 is a processor that controls the optical scanning device 100, the optical detector 400, and the signal processing circuit 600. The control circuit 500 controls the timing of exiting of the light beam from the optical scanning device 100, the exposure timing of the optical detector 400, and the timing of reading the signal therefrom, and instructs the signal processing circuit 600 to create the distance measurement image.

A frame rate used in the two-dimensional scan to obtain the distance measurement image can be selected from, for example, 60 fps, 50 fps, 30 fps, 25 fps, 24 fps, and so on which are generally used to obtain moving images. In consideration of an application to an on-vehicle system, as the frame rate increases, a frequency of obtaining the distance measurement image increases and an obstacle can be detected with higher accuracy. For example, when a vehicle with the frame rate of 60 fps runs at 60 km/h, the image can be obtained each time the vehicle moves about 28 cm. When the frame rate is 120 fps, the image can be obtained each time the vehicle moves about 14 cm. When the frame rate is 180 fps, the image can be obtained each time the vehicle moves about 9.3 cm.

A time requited to obtain one distance measurement image depends on the speed of a beam scan. For example, to obtain an image with the number of resolution points of 100×100 at the frame rate of 60 fps, the beam scan needs to be performed at 1.67 μs or below for each point. In that case, the control circuit 500 controls the exiting of the light beam from the optical scanning device 100 and accumulation and read of signals by and from the optical detector 400 at an operating speed of 600 kHz.

### Application Example to Light Receiving Device

The optical scanning device according to the above-described embodiment of the present disclosure can also be used as a light receiving device with substantially the same configuration. The light receiving device includes the same waveguide array 10A as that in the optical scanning device and a first adjuster adjusting a direction in which light is receivable. Each first mirror 30 in the waveguide array 10A allows light incident on a side opposite to the first reflecting surface from the third direction to pass therethrough. Each optical guide layer 20 in the waveguide array 10A allows the light having passed through the first mirror 30 to propagate in the second direction. The first adjuster can change the direction in which light is receivable by changing at least one of the refractive index or the thickness of the optical guide layer 20 in each waveguide element 10 or the light wavelength. When the light receiving device further includes the same phase shifters 80 as those in the optical scanning device and second adjusters changing a phase difference between the lights output from the waveguide elements 10 after passing through the phase shifters 80, the direction in which light is receivable can be two-dimensionally changed.

For example, the light receiving device can be constituted as a device in which the light source 130 in the optical scanning device 100 illustrated in FIG. 10 is replaced with a receiving circuit. When lights of the wavelength λ are incident on the waveguide array 10A, the lights are sent to the optical demultiplexer 90 through the phase shifter array 80A and are finally collected to one location to be sent to the receiving circuit. It can be said that intensity of the lights collected to the one location represents sensitivity of the light receiving device. The sensitivity of the light receiving device can be adjusted with adjusters that are separately incorporated in the waveguide array 10A and the phase shifter array 80A. Referring to FIG. 4, for example, the direction of the wave vector (denoted by the thick arrow in FIG. 4) is reversed in the light receiving device. The incident light has a light component in the direction in which the waveguide elements 10 extend (namely, in the X-direction in FIG. 4) and a light component in the direction in which the waveguide elements 10 are arrayed (namely, in the Y-direction in FIG. 4). The sensitivity for the light component in the X-direction can be adjusted with the adjuster incorporated in the waveguide array 10A. On the other hand, the sensitivity for the light component in the array direction of the waveguide elements 10 can be adjusted with the adjuster incorporated in the phase shifter array 80A. θ and α₀ illustrated in FIG. 4 can be determined from the phase difference Δϕ between the lights and the refractive index n_{w} and the thickness d of the optical guide layer 20 at which the sensitivity of the light receiving device is maximized. As a result, the incident direction of the light can be determined.

### Second Embodiment

An optical device according to a second embodiment of the present disclosure will be described below with reference to FIG. 13. The optical device is an optical fiber including a core and a cladding.

FIG. 13 is a schematic view illustrating an example of an optical fiber 100F according to the second embodiment of the present disclosure. In the example illustrated in FIG. 13, the optical fiber 100F according to the second embodiment includes a core 100c, a cladding 100d, and a film 22. The core 100c has a structure extending in the X-direction. Each of the film 22 and the cladding 100d also has a structure extending in the X-direction. The film 22 is a monomolecular film that is bonded to a surface of the core 100c through the siloxane bond. Details of the film 22 are as per described above. The cladding 100d is positioned around the core 100c with the film 22 interposed therebetween. The cladding 100d is held in contact with the film 22c. The cladding 100d has a lower refractive index than the core 100c. Light can propagate through the core 100c in the X-direction with total reflection.

As described above, the film 22 has good adhesion and high coverage performance. In the case of the core 100c being made of quartz and the cladding 100d being made of acrylic resin, therefore, when the film 22 is the monomolecular film 22 containing the alkyl group on a side opposite to the core 100c, bonding of the core 100c and the cladding 100d with the film 22 interposed therebetween provides greater bonding force than when the core 100c and the cladding 100d are directly bonded. In addition, since the light loss due to the film 22 is substantially negligible as described above, loss of the light propagating through the core 100c hardly generates.

The above-described embodiments can be combined with each other as appropriate.

The optical scanning device and the light receiving device according to the embodiments of the present disclosure can be utilized in applications to, for example, the LiDAR system mounted on vehicles such as a car, a UAV, and an AGV.

What is claimed is:

1. An optical device comprising:
a first substrate with a first surface spreading in a first direction and a second direction intersecting the first direction;
a second substrate with a second surface facing the first surface;
a film bonded to the first surface and/or the second surface through a siloxane bond; and
at least one optical guide layer positioned between the first substrate and the second substrate, the optical guide layer including a dielectric member in contact with the film and guiding light in the first direction and/or the second direction.

2. The optical device according to claim 1, further comprising:
at least one optical waveguide connected to the optical guide layer.

3. The optical device according to claim 2,
wherein a fore end portion of the optical waveguide is positioned between the first substrate and the second substrate, and
the optical waveguide includes a first grating in the fore end portion.

4. The optical device according to claim 2,
wherein the optical waveguide includes a portion not overlapping one of the first substrate and the second substrate when viewed from a direction perpendicular to the first surface, and
the optical waveguide includes a second grating in the not-overlapping portion.

5. The optical device according to claim 1,
wherein each of the first substrate and the second substrate includes a mirror,
the mirror in the first substrate has the first surface, and
the mirror in the second substrate has the second surface.

6. The optical device according to claim 1,
wherein the film is a monomolecular film.

7. The optical device according to claim 1, further comprising:
a structure enabling a refractive index of the dielectric member to be adjusted,
wherein a direction in which light is emitted from the optical guide layer through the first substrate or the second substrate or an incident direction in which light is taken into the optical guide layer through the first substrate or the second substrate is changeable by changing the refractive index of the dielectric member.

8. The optical device according to claim 7, further comprising:
a pair of electrodes sandwiching the optical guide layer therebetween,
wherein the dielectric member includes a liquid crystal material or an electro-optic material, and
the refractive index of the dielectric member is changeable by applying a voltage between the pair of electrodes.

9. The optical device according to claim 8,
wherein the dielectric member is made of the liquid crystal material, and
the film is a liquid crystal alignment film in which an alignment direction is defined with rubbing.

10. The optical device according to claim 8,
wherein the dielectric member is made of the liquid crystal material, and
the film is a liquid crystal alignment film in which an alignment direction is defined with polarized irradiation.

11. The optical device according to claim 1, further comprising:
phase shifters each connected to the optical guide layer directly or via another waveguide,
wherein a direction in which light is emitted from the optical guide layer through the first substrate or the second substrate or an incident direction in which light is taken into the optical guide layer through the first substrate or the second substrate is changed by changing a phase difference between lights passing through the phase shifters.

12. An optical detection system comprising:
the optical device according to claim 1;
an optical detector that detects light emitted from the optical device and reflected by an object; and
a signal processing circuit that creates distance distribution data based on an output of the optical detector.
